(19) United States
(12) Patent Application Publication
(10) Pub. No.: US 2009/0155683 A1
(43) Pub. Date: Jun. 18, 2009

(54) INSULATING CASE FOR SECONDARY BATTERY AND SECONDARY BATTERY USING THE SAME

(76) Inventor: Min-Jung Yoo, Suwon-si (KR)

Correspondence Address: CHRISTIE, PARKER & HALE, LLP, PO BOX 7068, PASADENA, CA, 91109-7068, US

(21) Appl. No.: 12/244,675

(22) Filed: Oct. 2, 2008

(30) Foreign Application Priority Data
Dec. 13, 2007 (KR) 10-2007-0129875

(51) Int. Cl. H01M 2/02; H01M 10/00

(52) U.S. Cl. 429/163

(57) ABSTRACT

An insulating case for a secondary battery includes a main body and a support projecting upward from an edge of the main body such that an internal angle between the support and the main body is an obtuse angle. Further, a secondary battery including an electrode assembly, a can housing the electrode assembly, the can having an opening, a cap assembly covering the opening of the can, and an insulating case on the electrode assembly, the insulating case including a main body and a support projecting upward from an edge of the main body, wherein an internal angle between the support and the main body is an obtuse angle.

### CROSS-REFERENCE TO RELATED APPLICATION

This application claims priority to and the benefit of Korean Patent Application No. 10-2007-0129875, filed Dec. 13, 2007, the entire content of which is incorporated herein by reference.

### BACKGROUND OF THE INVENTION

1. Field of the Invention

The present invention relates to an insulating case for a secondary battery and a secondary battery using the same.

2. Description of the Related Art

Secondary batteries are more economical than disposable batteries since secondary batteries are rechargeable. Moreover, as secondary batteries have become smaller and have higher capacity, they are widely used as power sources of handheld electronic appliances such as mobile phones, notebook computers, camcorders, digital cameras, and so forth.

Such secondary batteries include nickel-cadmium batteries, nickel-metal hydride batteries, nickel-zinc batteries, lithium ion secondary batteries, and lithium polymer secondary batteries. Among secondary batteries, lithium secondary batteries are widely used due to their compact size, high capacity, high operating voltage and higher energy density per unit weight than other batteries.

Lithium secondary batteries are classified into a can type and a pouch type according to the shape of an outer casing accommodating an electrode assembly including a positive electrode plate, a negative electrode plate and a separator, and the can type may be sub-classified into a cylinder type and a prismatic type.

In can-type lithium secondary batteries, an outer casing is generally formed of metal such as aluminum, and formed in a cylinder shape, a prismatic shape or a rod shape having rounded corners. An opening may be formed at one side of the can, and an electrode assembly and an electrolyte are inserted into the can through the opening which is then sealed with a cap assembly.

The prismatic-type lithium secondary battery includes an insulating case disposed at an upper portion of an electrode assembly to prevent movement of the electrode assembly accommodated in the can. The insulating case may include a flat panel and a support projecting upward from an edge of the flat panel. The support may be formed to be in contact with an inner wall of the can to be fixed thereto.

However, since a conventional support is perpendicular to a flat panel, a gap may be created between an inner wall of the can and the support when the insulating case is erroneously formed (e.g., made small) or misshapen. Thus, it may be difficult to prevent the movement of the insulating case and the electrode assembly relative to the can.

Also, when the electrode assembly moves within the can, a crack may be formed in an electrode tab connected with the electrode assembly or the electrode tab may be separated from the electrode assembly and short-circuited with a terminal having an opposite polarity.

### SUMMARY

Embodiments of the present invention are directed to providing an insulating case for a secondary battery, and a secondary battery using the same, which may prevent or significantly reduce the movement of an electrode assembly within a can and increase stability.

According to one aspect of the present invention, a secondary battery is provided including an electrode assembly, a can housing the electrode assembly, the can having an opening, a cap assembly covering the opening of the can, and an insulating case on the electrode assembly. The insulating case includes a main body and a support projecting upward from an edge of the main body, wherein an internal angle between the support and the main body is an obtuse angle. More specifically, the internal angle may be about 90 degrees to about 95 degrees.

In one embodiment, the main body is substantially planar. Further, there may be a plurality of supports, and the supports may extend along one or both long and/or short sides of the main body. In one embodiment, the support may have a groove at an upper end of the support.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view of a secondary battery according to an embodiment of the present invention.

FIG. 2 is a cross-sectional view of the secondary battery of FIG. 1.

FIG. 3A is a perspective view of an insulating case according to a first embodiment of the present invention.

FIG. 3B is a front view of the insulating case viewed from direction A of FIG. 3A.

FIGS. 3C, 3D and 3E are perspective views of an insulting case according to second, third and fourth exemplary embodiments of the present invention, respectively.

### DETAILED DESCRIPTION

The above and other objects, features and functions of the present invention will be described more fully with reference to the accompanying drawings. Moreover, in the drawings, the lengths and thicknesses of a layer and a region may be exaggerated for clarity. Also, like reference numerals denote like elements throughout the specification.

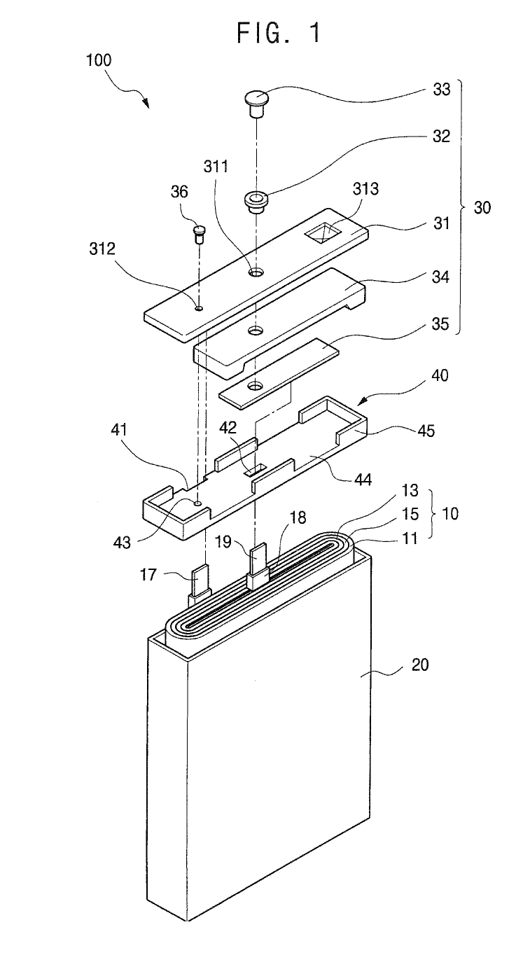

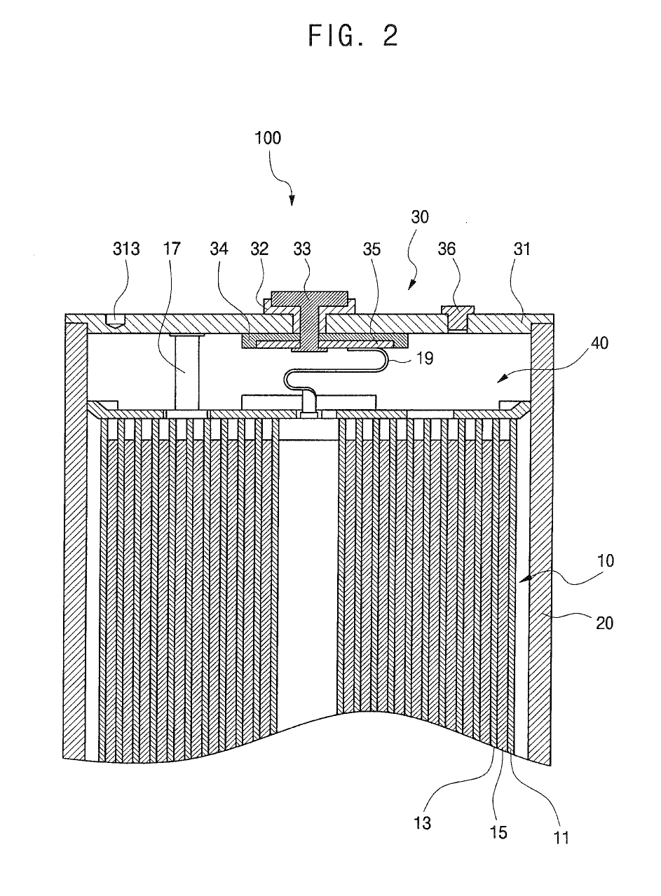

FIG. 1 is an exploded perspective view of a secondary battery according to an exemplary embodiment of the present invention, and FIG. 2 is an assembled cross-sectional view of the secondary battery of FIG. 1.

Referring to FIGS. 1 and 2, a secondary battery 100 includes an electrode assembly 10, a can 20 for accommodating the electrode assembly 10, and a cap assembly 30 covering an opening of the can 20. Further, the secondary battery 100 includes an insulating case 40 disposed at an upper portion of the electrode assembly 10 accommodated in the can 20.

The electrode assembly 10 may include a first electrode plate 11, a second electrode plate 13 and a separator 15 sequentially stacked and wound in a jelly-roll configuration. Hereinafter, the first electrode plate 11 is referred to as a positive electrode plate, and the second electrode plate 13 is referred to as a negative electrode plate. However, it will be appreciated that polarities of the first and second electrode plates 11, 13 may be changed depending on the process of forming these electrode plates.

The positive electrode plate 11 may be formed by applying a positive electrode active material to a positive electrode collector formed of aluminum, and may include a positive electrode non-coating portion absent the positive electrode active material. The negative electrode plate 13 is formed by applying a negative electrode active material to a negative electrode collector formed of copper, and includes a negative electrode non-coating portion absent the negative electrode active material. The separator 15 is interposed between the positive electrode plate 11 and the negative electrode plate 13 to prevent a short circuit therebetween, and has a porous surface acting as a channel for lithium ions.

A first electrode tab 17 is attached to the positive electrode non-coating portion to be electrically connected with a cap plate 31 of the cap assembly 30. Further, a second electrode tab 19 is attached to the negative electrode non-coating portion to be electrically connected with an electrode terminal 33 of the cap assembly 30. Thus, the first electrode tab 17 has the same polarity as the first electrode plate 11, and the second electrode tab 19 has the same polarity as the second electrode plate 13. Hereinafter, the first electrode tab 17 is referred to as a positive electrode tab, and the second electrode tab 19 is referred to as a negative electrode tab.

The positive and negative electrode tabs 17, 19 may be formed of nickel, and may be attached to the positive and negative electrode non-coating portions by ultrasonic welding or laser welding, but the present invention is not limited to the materials and attachment methods disclosed herein.

Boundary parts of the positive and negative electrode tabs 17, 19 which extend from the wound electrode assembly 10 may be wound with insulating tape 18 to prevent a short circuit between the electrodes 11, 13.

The positive electrode collector may be formed of stainless steel, nickel, aluminum, titanium, an alloy thereof, or carbon-, nickel-, titanium- or silver-treated aluminum or stainless steel. Further, the positive electrode collector may be formed in the form of a foil, a film, a sheet, a punched hole, a porous body, or a foaming agent, usually formed to a thickness of between about 1 to 50 μm, and preferably between about 1 to 30 μm. The present invention is not limited to the type and thickness described herein. The positive electrode active material serves to intercalate or deintercalate lithium ions and may comprise a material selected from the group consisting of cobalt, manganese, nickel, and combinations thereof, or at least one of lithium composite oxides.

The negative electrode collector may be formed of stainless steel, nickel, copper, titanium, an alloy thereof, or carbon-, nickel-, titanium- or silver-treated copper or stainless steel. The negative electrode collector may be formed in the form of a foil, a film, a sheet, a punched hole, a porous body, or a foaming agent, and is formed to a thickness of between about 1 to 50 μm, and preferably 1 to 30 μm. The present invention is not limited to the type and thickness described herein. The negative electrode active material serves to intercalate or deintercalate lithium ions, and may include carbonic substances such as crystalline carbon, amorphous carbon, carbon complex and carbon fiber, lithium metal, or lithium alloys.

The separator 15 may be formed of a common material, for example, a thermoplastic resin such as polyethylene (PE) or poly propylene (PP), and may have a porous surface. Since the porous separator 15 melts at a temperature similar to a melting point of the thermoplastic resin reached due to an increase in internal temperature of the battery, the porosity of the separator may be blocked, thus preventing the separator from acting as an insulating film. Accordingly, the migration of the lithium ions between the positive and negative electrode plates 11, 13 is interrupted to block the flow of current, thereby stopping an increase in internal temperature of the battery.

The can 20 may be formed of a metallic material having an opening on the top thereof for accommodating the electrode assembly 10 and an electrolyte. The insulating case 40 is disposed at an upper portion of the electrode assembly 10. The metallic material may include aluminum, an aluminum alloy or stainless steel, which is light and flexible. Thus, when the can 20 is formed of such a metallic material, the can may be used as an electrode terminal because of its polarity.

The can 20 may be formed in a prismatic or oval shape, and the open top thereof may be welded or thermally fused with the cap plate 31 to be sealed. The cap assembly 30 includes the cap plate 31, an insulating gasket 32, an electrode terminal 33, an insulating plate 34, a terminal plate 35 and an electrolyte inlet plug 36.

The cap plate 31 is coupled to the opening of the can 20 to seal the opening of the can 20, and has about the same size and shape as the opening. The cap plate 31 has a terminal through-hole 311 into which the insulating gasket 32 and the electrode terminal 33 are inserted.

Further, in the cap plate 31, an electrolyte inlet 312 is formed to permit injection of an electrolyte into the can 20. The electrolyte inlet plug 36 is coupled to the electrolyte inlet 312 to seal it.

A vent 313 having a notch is formed in the cap plate 31. Thus, the vent is easily fractured to exhaust gases when an inner pressure of the battery increases to a threshold level.

The insulating gasket 32 is coupled to the terminal through-hole 311 formed in the cap plate 31, and formed of an insulating material to insulate the electrode terminal 33 from the cap plate 31. Furthermore, a hole is formed in the center of the insulating gasket 32 to allow the electrode terminal 33 to be coupled to the insulating gasket.

The electrode terminal 33 is inserted into the hole formed in the insulating gasket 32 to be coupled to the cap plate 31. As such, a lower portion of the electrode terminal 33 is connected with the terminal plate 35 through the cap plate 31.

The insulating plate 34 is disposed under the cap plate 31 to insulate an outer surface of the terminal plate 35, and has a hole to connect the electrode terminal 33 with the terminal plate 35. The terminal plate 35 is disposed under the insulating plate 34 and formed of a conductive material. Thus, the terminal plate 35 is connected with the electrode terminal 33 to form an electrical path. Since the negative electrode tab 19 is disposed under the terminal plate 35 to be electrically connected therewith, the electrode terminal 33 serves as a negative terminal.

The insulating case 40 is disposed at an upper portion of the electrode assembly 10 inserted into the can 20 to prevent the movement of the electrode assembly 10. Further, the insulating case 40 has a tab groove 41 and a tab hole 42 for spacing the positive and negative electrode tabs 17,19 from each other to prevent a short circuit, and that serve as a guide to project the tabs therefrom. Furthermore, the insulating case 40 may have an injection hole 43 functioning as a passage to allow the electrolyte to be easily injected through the electrode assembly 10.

The insulating case 40 may include a planar main body 44, and at least one support 45 projecting from an edge of the main body 44 in one direction. Hereinafter, the direction in which the support 45 projects is referred to as an upward direction. The tab groove 41, the tab hole 42 and the injection hole 43 may be formed in the main body 44.

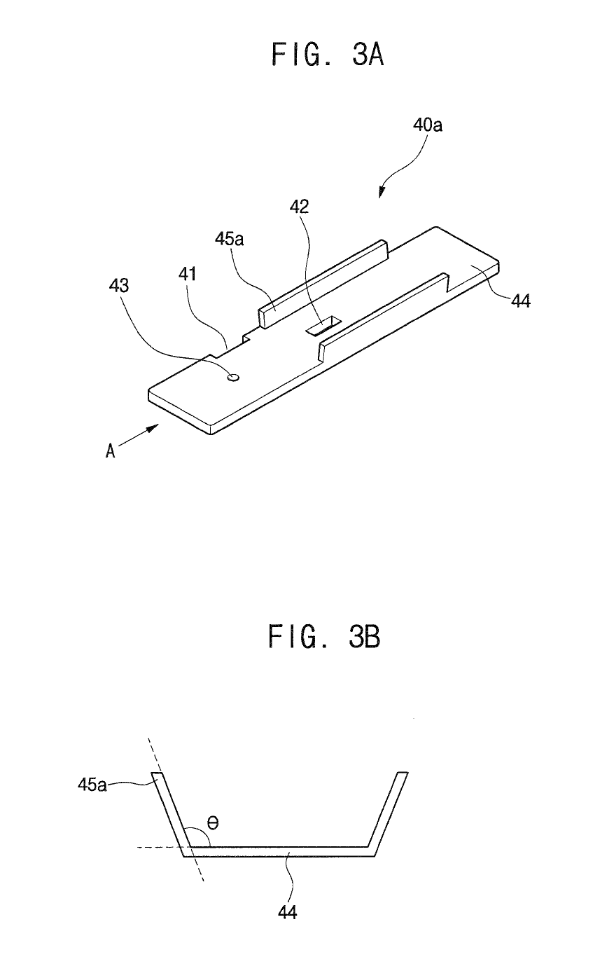

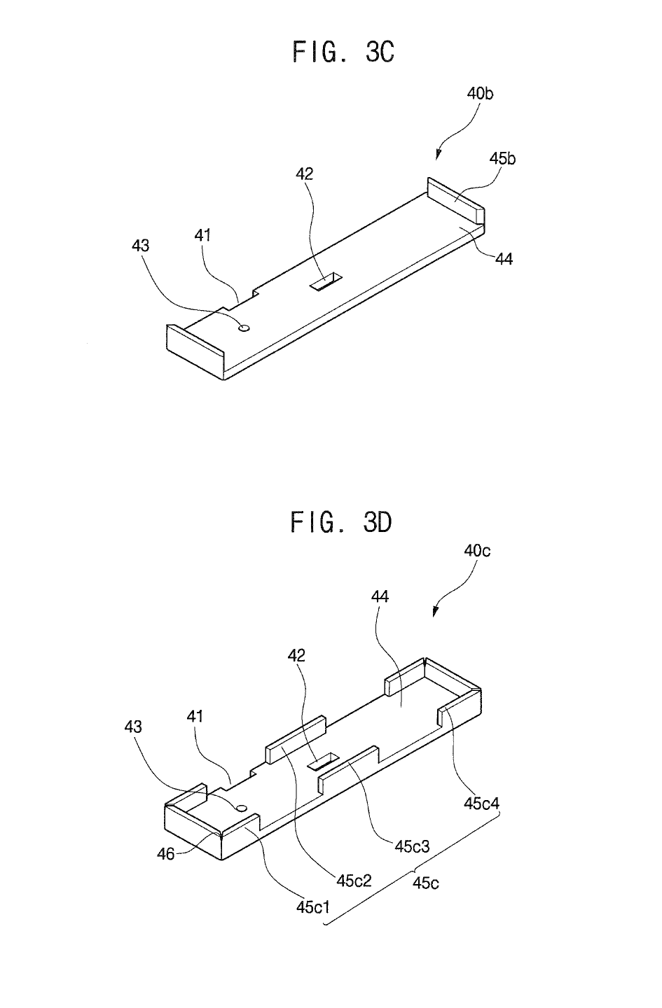

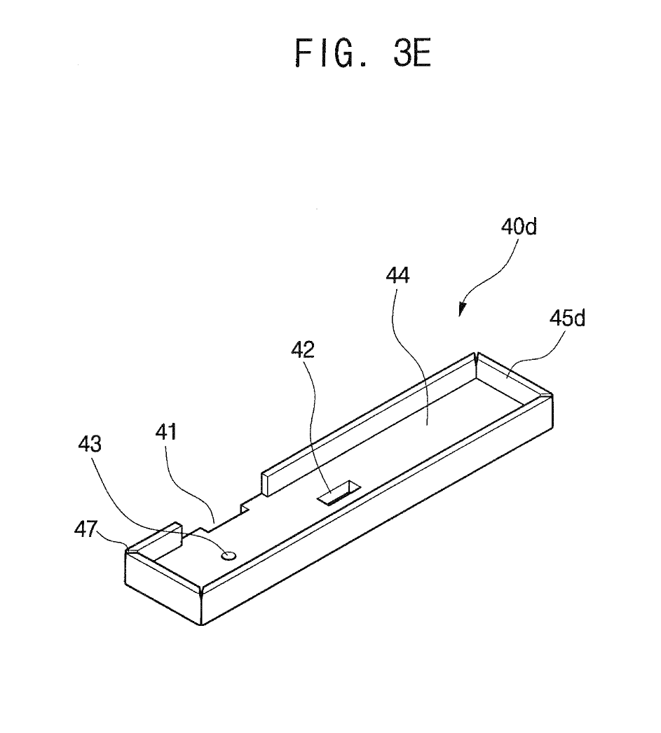

FIG. 3A is a perspective view of an insulating case according to a first exemplary embodiment of the present invention, and FIG. 3B is a front view of the insulating case viewed from direction A of FIG. 3A. Referring to FIGS. 3A and 3B, a support 45a may project upward from an edge of one long side of the main body 44, or edges of both long sides of the main body 44 as shown in the present exemplary embodiment. The support 45a may be formed in equal or different numbers at edges of both long sides of the main body 44. An internal angle between the support 45a and the main body 44 may be an obtuse angle e that is greater than 90 degrees, as illustrated in FIG. 3B.

Accordingly, when the insulating case 40a is inserted into the can 20, the support 45a forming an obtuse angle with the main body 44 may be closely attached to and snug with the inner sidewall of the can 20 to prevent or significantly reduce relative movement of the insulating case 40a with respect to the can. The larger the internal angle between the support 45a and the main body 44 of the insulating case 40a inserted into the can 20, the greater a distance between the can 20 and the insulating case 40a. When the distance between the can 20 and the insulating case 40a is too great, the movement of the insulating case 40a cannot be easily prevented by the support 45a. Thus, the internal angle between the support 45a and the main body 44 of the insulating case 40a inserted into the can 20 may be greater than 90 degrees and less than or equal to 95 degrees.

Referring to FIG. 3C illustrating a perspective view of an insulating case according to a second exemplary embodiment of the present invention, a support 45b may project upward from an edge of one short side (or lateral side) of the main body 44, or edges of both short sides of the main body 44 as shown in the present exemplary embodiment. The support 45b may be formed in equal or different numbers at edges of both short sides of the main body 44. Like the previous exemplary embodiment, the support 45b forms an obtuse angle with the main body 44 to prevent or substantially reduce the movement of the insulating case 40b relative the can 20.

In addition, an internal angle between the support 45b and the main body 44 of the insulating case 40b inserted into the can 20 may be greater than 90 degrees and less than or equal to 95 degrees.

Referring to FIGS. 3D and 3E illustrating perspective views of an insulating case according to third and fourth exemplary embodiments of the present invention, supports 45c, 45d may project upward from edges of both long and short sides of the main body 44. The support 45c may be separated into several sections 45c1 to 45c4 as illustrated in FIG. 3D, and the support 45d may be formed as a single piece as illustrated in FIG. 3E. As illustrated in FIGS. 3D and 3E, grooves 46, 47 may be formed between upper ends of the supports 45c, 45d formed at the edges of the main body 44. When the grooves 46, 47 are formed, insulating cases 40c, 40d may be easily inserted into the can 20.

In addition, the supports 45c, 45d form an obtuse angle with the main body 44 to prevent or substantially reduce the movement of the insulating cases 40c, 40d with respect to the can 20. Here, an internal angle between the supports 45c, 45d and the main body 44 of the insulating cases 40c, 40d inserted into the can 20 may be greater than 90 degrees and less than or equal to 95 degrees.

Since a support formed at an insulating case is closely attached to a can, the movement of the insulating case and an electrode assembly with respect to the can may be prevented or substantially reduced, and stability can be improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An insulating case for a secondary battery comprising:
a main body; and
a support projecting upward from an edge of the main body such that an internal angle between the support and the main body is an obtuse angle.

2. The insulating case according to claim 1, wherein the support comprises at least one piece.

3. The insulating case according to claim 1, wherein the main body is substantially planar.

4. The insulating case according to claim 3, wherein the support extends along one short side or one long side of the main body.

5. The insulating case according to claim 3, wherein the support extends along two short sides or two long sides of the main body.

6. The insulating case according to claim 3, wherein the support extends along a short side and a long side of the main body.

7. The insulating case according to claim 6, wherein the support has a groove at an upper end of the support.

8. A secondary battery comprising:
an electrode assembly;
a can housing the electrode assembly, the can having an opening;
a cap assembly covering the opening of the can; and
an insulating case on the electrode assembly, the insulating case comprising a main body and a support projecting upward from an edge of the main body, wherein an internal angle between the support and the main body is an obtuse angle.

9. The secondary battery according to claim 8, wherein the internal angle is greater than 90 degrees and less than or equal to 95 degrees.

10. The secondary battery according to claim 8, wherein the support comprises at least one piece.

11. The secondary battery according to claim 8, wherein the main body is substantially planar.

12. The secondary battery according to claim 11, wherein the support extends along one short side or one long side of the main body.

13. The secondary battery according to claim 11, wherein the support extends along two short sides or two long sides of the main body.

14. The secondary battery according to claim 10, wherein the support extends along a short side and a long side of the main body.

15. The secondary battery according to claim 14, wherein the support has a groove at an upper end of the support.

16. The secondary battery according to claim 8, wherein the secondary battery is a prismatic battery.
